(19) United States
(12) Patent Application Publication
(10) Pub. No.: US 2026/0361360 A1
(43) Pub. Date: Nov. 12, 2026

(54) METHODS AND APPARATUS FOR NETWORK ENERGY SAVING OPERATION TO INDICATE CHANGE IN TCI STATES DUE TO DYNAMIC ADAPTATION OF SPATIAL ELEMENTS IN A WIRELESS COMMUNICATION SYSTEM

(71) Applicant: SAMSUNG ELECTRONICS CO., LTD., Suwon-si, Gyeonggi-do (KR)

(72) Inventors: Santanu MONDAL, Bangalore (IN); Diwakar SHARMA, Bangalore (IN); Dattaraj Dileep Raut MULGAONKAR, Bangalore (IN); Karthik MURALIDHAR, Bangalore (IN)

(21) Appl. No.: 19/473,056

(22) PCT Filed: Apr. 3, 2024
(86) PCT No.: PCT/KR2024/004302

§ 371 Date: Oct. 6, 2025

(30) Foreign Application Priority Data
Apr. 7, 2023 (IN) 202341026270
Aug. 11, 2023 (IN) 202341054180
Mar. 27, 2024 (IN) 202341026270

(51) Int. Cl. H04B 7/06; H04L 5/00; H04W 72/232

(52) U.S. Cl. CPC H04B 7/0626; H04B 7/06952; H04L 5/0051; H04W 72/232

(57) ABSTRACT

The disclosure relates to a 5G or 6G communication system for supporting a higher data transmission rate. Embodiments disclosed herein provide a method for indicating change in TCI states due to dynamic adaptation of spatial elements in wireless network. The method includes detecting a TCI state for a PDCCH, wherein the TCI state defines a QCL relationship between DL RSs in at least one CSI-RS resource set and at least one DM-RS port of the PDCCH. Further, the method includes changing the QCL relationship between the DL RSs in the at least one CSI-RS resource set and the at least one DM-RS port of the PDCCH in the TCI state based on a plurality of parameters, and SD and PD adaption. The changed TCI state is indicated to at least one UE associated with network apparatus (201) in the wireless network.

### TECHNICAL FIELD

The present application is based on and claims priority from an Indian Provisional Application Number 202341026270 filed on 7 Apr. 2023, and Indian Provisional Application Number 202341054180 filed on 11 Aug. 2023, the disclosure of which are hereby incorporated by reference herein. The proposed embodiments relate to a wireless network. More particularly relates to indicating change in Transmission Configuration Indicator (TCI) states due to dynamic adaptation of spatial elements in wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to indicate change in TCI states due to dynamic adaption of spatial elements.

### Solution to Problem

In one aspect the objects are achieved by providing a method for indicating change in TCI states due to dynamic adaptation of spatial elements in wireless network. The method includes detecting a TCI state for a PDCCH, wherein the TCI state defines a QCL relationship between DL RSs in at least one CSI-RS resource set and at least one Demodulation Reference Signal (DM-RS) port of the PDCCH. Further, the method includes changing the QCL relationship between the DL RSs in the at least one CSI-RS resource set and the at least one DM-RS port of the PDCCH in the TCI state based on a plurality of parameters, and SD and PD adaption. The changed TCI state is indicated to at least one UE associated with the network apparatus in the wireless network.

In an embodiment, the plurality of parameters includes a feedback from a user of the at least one UE, a resource mapping, a power control parameter, a power control offset, muting pattern of antenna ports, antenna elements, joint adaptation of antenna ports, elements or power offset.

In an embodiment, the method includes receiving a CSI feedback from the at least one UE associated with the network apparatus in the wireless network, and muting at least one of ‘at least one CSI-RS port from the at least one CSI-RS resource set’, and ‘at least one spatial element of a plurality of spatial elements within at least one CSI-RS port of a CSI-RS resource from the at least one CSI-RS resource set’ based on the plurality of parameters, and the CSI feedback received from the at least one UE. Further, the changed QCL relationship is regenerated in the TCI state based on the at least one of ‘the at least one muted CSI-RS port of the CSI-RS resource from the at least one CSI-RS’ resource and ‘the at least one muted spatial element within at least one CSI-RS port of the CSI-RS resource from the at least one CSI-RS resource set’.

In an embodiment, the method includes receiving the CSI feedback from the at least one UE associated with the network apparatus in the wireless network, and unmuting at least one of ‘the at least one muted CSI-RS port of the CSI-RS resource from the at least one CSI-RS resource set’, and ‘at least one spatial element of the plurality of spatial elements within the at least one CSI-RS port of the CSI-RS resource from the at least one CSI-RS set’ based on the plurality of parameters, and the CSI feedback received from the at least one UE. Further, the changed QCL relationship is regenerated in the TCI state based on the at least one of ‘the at least one unmuted CSI-RS port of the CSI-RS resource from the at least one CSI-RS resource set’ and ‘the at least one unmuted spatial element within at least one CSI-RS port from the at least one CSI-RS resource set’.

In an embodiment, the method includes sending a configuration message comprising at least one power adaptation information to trigger at least one beam measurement report from the at least one UE, and receiving the at least one beam measurement report from the at least one UE. Further the method includes regenerating a changed QCL relationship in the TCI state based on the at least one power adaptation information and the at least one beam measurement report. In an embodiment, the method includes indicating the at least one power adaptation information of the at least one CSI-RS port of the CSI-RS resource from the at least one CSI-RS resource set to the at least one UE, and receiving a measurement report from the at least one UE based on the at least one power adaptation information, wherein the measurement report comprises a preference and measurement information of the at least one power adaptation information of the at least one CSI-RS port of the CSI-RS resource from the at least one CSI-RS resource set. Further, the configuration message comprising the at least one power adaptation information is sent to the at least one UE in the wireless network based on the measurement report.

In an embodiment, the power adaption information comprises status of the at least one of ‘at least one CSI-RS port of the CSI-RS resource from the at least one CSI-RS resource set’, and ‘at least one spatial element of the plurality of spatial elements within at least one CSI-RS port of the CSI-RS resource from the at least one CSI-RS resource set’.

In an embodiment, the changed TCI state is indicated in one of a MAC-CE activation message, and a DCI Indication message. Wherein the MAC-CE activation message comprises an identifier of a CSI-RS resource sub-configuration, TCI indexes corresponding to the changed TCI state in the CSI-RS resource sub-configurations. The DCI message comprises an identifier of a CSI-RS resource sub-configuration, TCI indexes corresponding to the changed TCI state in the CSI-RS resource sub-configurations.

In an embodiment, the method includes transmitting a CSI-RS resource sub-configuration across at least one of one or more BWP and one or more CC based on the changed TCI state to operate the at least one UE with the one or more CC in the one or more BWP.

In an embodiment, the method includes evaluating SD and PD sub-configurations associated with the SD and PD adaption to form a candidate set, wherein the candidate set is a set of spatial domain muting pattern or power offsets based sub configurations considered for SD/PD adaption. Further, the method includes transmitting at least one CSI-RS resource from the at least one CSI-RS resource set for the candidate set of the SD and PD sub-configurations, and receiving at least one CSI report for the candidate set of SD and PD sub-configurations. Further, at least one CSI-RS port of the CSI-RS resource from the at least one CSI-RS resource set to be activated is selected based on the at least one CSI report for the candidate set of SD and PD sub-configurations. The at least one of SD and PD sub-configurations for the at least one CSI-RS port of the CSI-RS resource from the at least one CSI-RS resource set is activated.

In an embodiment, the method includes transmitting the at least one activated SD and PD sub-configurations for the at least one CSI-RS port of the CSI-RS resource from the at least one CSI-RS resource set, and receiving at least one CSI feedback report for the at least one activated SD and PD sub-configurations for the at least one CSI-RS port of the CSI-RS resource from the at least one CSI-RS resource set from the UE. Further the method includes triggering the UE to send at least one CSI feedback report for the candidate set of SD and PD sub-configurations and receiving the at least one CSI feedback report for the candidate set of SD and PD sub-configurations.

In an embodiment, the method includes configuring the at least one CSI-RS from the at least one CSI-RS resource set for the at least one activated SD and PD sub-configurations for the at least one of the CSI-RS resource from of the CSI-RS resource the at least one CSI-RS resource set to the UE, and receiving at least one CSI feedback report for the at least one activated SD and PD sub-configurations for the at least one CSI-RS port of the CSI-RS resource from the at least one CSI-RS set from the UE. The at least one CSI feedback report for the candidate set of SD and PD sub-configurations is received at the network apparatus.

In an embodiment the at least one CSI-RS from the at least one CSI-RS resource set for the configured candidate set of the SD and PD sub-configurations is transmitted on periodic, aperiodic and semi-persistent basis.

In an embodiment, the at least one CSI-RS from the at least one CSI-RS resource set for the at least one of the candidate set of SD and PD sub-configurations and the active SD and PD sub-configurations is configured on periodic, aperiodic and semi-persistent basis.

In an embodiment, association of the SD and PD sub-configurations with TCI states comprises at least one of reusing at least one TCI-ID for the each SD and PD sub-configurations, and splitting the at least one TCI-ID into multiple pool of ID(s) and associating each pool with the SD and PD sub-configurations.

In another aspect the objects are achieved by providing a network apparatus for indicating change in TCI states due to dynamic adaptation of spatial elements in wireless network. The network apparatus detects the TCI state for the PDCCH, wherein the TCI state defines the QCL relationship between DL RSs in at least one CSI-RS resource set and at least one DM-RS port of the PDCCH. Further, the network apparatus changes the QCL relationship between the DL RSs in the at least one CSI-RS resource set and the at least one DM-RS port of the PDCCH in the TCI state based on the plurality of parameters, and the SD and PD adaption. The changed TCI state is indicated to at least one UE associated with the network apparatus in the wireless network.

These and other aspects of the embodiments herein will be better appreciated and understood when considered in conjunction with the following description and the accompanying drawings. It is understood, however, that the following descriptions, while indicating preferred embodiments and numerous specific details thereof, are given by way of illustration and not of limitation. Many changes and modifications be made within the scope of the embodiments herein without departing from the spirit thereof, and the embodiments herein include all such modifications.

### Advantageous Effects of Invention

According to an embodiment of the disclosure, a wireless communication can be performed efficiently. Especially, network energy saving operation can be performed efficiently.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1A illustrates an overview of wireless network for managing energy usage, accordingly to embodiments as disclosed herein;

FIG. 1B is schematic diagram that illustrates AAS, according to prior art.

FIG. 2 is a block diagram of network apparatus for indicating change in TCI states due to dynamic adaptation of spatial elements in the wireless network, accordingly to embodiments as disclosed herein;

FIG. 3A depicts a type 1 SD adaption of CSI-RS ports for the network energy saving, accordingly to the embodiments as disclosed herein;

FIG. 3B depicts a type 2 SD adaption of the CSI-RS ports for the network energy saving, accordingly to the embodiments as disclosed herein;

FIG. 3C depicts transmission of CSI-RS resource sub-configuration across BWP and CC based on the changed TCI state, accordingly to the embodiments as disclosed herein;

FIG. 4 is a schematic diagram that illustrates indication of the TCI state change due to adaption of the spatial elements, accordingly to the embodiments as disclosed herein;

FIG. 5 is a schematic diagram that illustrates QCL types in beam management, accordingly to the embodiments as disclosed herein;

FIG. 6 is a schematic diagram that illustrates association of the TCI states with SD and PD sub-configurations, accordingly to the embodiments as disclosed herein;

FIG. 7 is a schematic diagram that illustrates impact on beam application time in indicating changed TCI states to the UE, accordingly to the embodiments as disclosed herein;

FIG. 8 is a sequence diagram that illustrates indicating change in the TCI state in the wireless network system, accordingly to the embodiments disclosed herein;

FIG. 9 is a flow diagram the illustrates transmission of the CSI-RS from the CSI-RS set associated with the SD and PD sub-configurations configured for the SD and PD adaption, accordingly to the embodiments as disclosed herein; and

FIG. 10 is a flow diagram the illustrates transmission of the CSI-RS from the CSI-RS set associated with the SD and PD sub-configurations configured for the SD and PD adaption, accordingly to another embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Recent advancements in 5th Generation (5G) or New Radio (NR) mobile communications have gained significant traction worldwide, driven by extensive technical efforts across industry and academia. Key technologies enabling 5G/NR mobile communications include massive antenna technologies spanning legacy cellular frequency bands to high frequencies, facilitating beamforming gain and increased capacity. Additionally, new waveform technologies, such as novel Radio Access Technologies (RATs), offer flexibility to accommodate diverse services and applications with varying requirements. Multiple access schemes have also been developed to support massive connections.

A considerable portion of energy consumption in modern networks is attributed to the radio access network, particularly the Active Antenna System (AAS). This energy usage can be categorized into dynamic consumption during data communication and static consumption for network maintenance, even during periods of inactivity. While User Equipment (UE) power consumption has been extensively studied, there is a growing recognition of the need to address power consumption on the network side, especially at the base station level.

Various techniques have been proposed to facilitate energy savings in base stations, including cell activation/deactivation mechanisms. Some UE power-saving techniques, such as discontinuous reception (DRX) and cell dormancy mechanisms, may indirectly contribute to base station energy savings through parameter optimization. Furthermore, base stations can optimize energy usage by configuring physical channels, signals, and resources for UEs. However, detailed consideration of network-side energy-saving strategies at the system level remains a challenge.

In NR, beamforming-based directional links necessitate precise alignment of transmitter and receiver beams, achieved through beam management operations. One such operation involves beam management with indication, c considering Quasico-location (QCL) to provide instructions to UEs for adjusting receiver settings.

Thus, it is desired to address the above-mentioned disadvantages or other shortcomings or at least provide a useful alternative to overcome the inter-device connection setup problems and synchronization problems.

The principal object of the embodiments herein is to provide a network apparatus and method for indicating change in TCI states due to dynamic adaptation of spatial elements in wireless network. In the proposed solution, the TCI states are changed by Spatial Domain (SD) and Power Domain (PD) adaption of Channel State Indicator-Reference Signal (CSI-RS) ports of AAS of the network apparatus.

Another object the embodiments herein is to changes the TCI states by changing QCL relationship between Downlink Reference Signal (DL RSs) in the at least one CSI-RS resource set and the at least one DM-RS port of Physical Downlink Control Channel (PDCCH) based on a plurality of parameters, and SD and PD adaption.

Yet another object the embodiments herein is to indicate the changed TCI state to at least one UE associated with the network apparatus in the wireless network. The changed TCI state is indicated in one of a Medium Access Control-Control Element (MAC-CE) activation message, and a Downlink Scheduling Control Information (DCI) Indication message.

Yet another object of the embodiments herein is to transmit a CSI-RS resource sub-configuration across at least one of one or more Bandwidth Part (BWP) and one or more Component Carrier (CC) based on the changed TCI state to operate the at least one UE with the one or more CC in the one or more BWP.

Yet another object of the embodiment herein is to transmit CSI-RS from the CSI-RS resource set associated with SD and PD sub-configurations configured for the SD and PD adaption in the wireless network.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Embodiments disclosed herein provide a method for indicating change in TCI states due to dynamic adaptation of spatial elements in wireless network. The method includes detecting a TCI state for a PDCCH, wherein the TCI state defines a QCL relationship between DL RSs in at least one CSI-RS resource set and at least one Demodulation Reference Signal (DM-RS) port of the PDCCH. Further, the method includes changing the QCL relationship between the DL RSs in the at least one CSI-RS resource set and the at least one DM-RS port of the PDCCH in the TCI state based on a plurality of parameters, and SD and PD adaption. The changed TCI state is indicated to at least one UE associated with the network apparatus in the wireless network.

Embodiments disclosed herein provide the network apparatus for indicating change in TCI states due to dynamic adaptation of spatial elements in wireless network. The network apparatus detects the TCI state for the PDCCH, wherein the TCI state defines the QCL relationship between DL RSs in at least one CSI-RS resource set and at least one DM-RS port of the PDCCH. Further, the network apparatus changes the QCL relationship between the DL RSs in the at least one CSI-RS resource set and the at least one DM-RS port of the PDCCH in the TCI state based on the plurality of parameters, and the SD and PD adaption. The changed TCI state is indicated to at least one UE associated with the network apparatus in the wireless network.

Embodiments include techniques for power savings in 5G NR. A first objective is to achieve more efficient operation dynamically and/or semi-statically and achieve finer granularity adaptation of transmissions/receptions. Network energy saving techniques may be in the time, frequency, spatial, and/or power domains. Some embodiments include support (e.g., feedback) from the UE to the base station (e.g., a gNB/MME/AMF), including receiving assistance information from the UE. A second objective is to accommodate information exchange and coordination over network interfaces. Embodiment power savings techniques may be advantageous over power savings techniques (such as simply turning off some components when there is no traffic associated with them).

In an embodiment, spatial elements encompass a range of components including antenna elements, TxRUs (featuring sub-array/full-connection), antenna panels, and TRxPs (which can be either co-located or geographically separated). Additionally, logical antenna ports are utilized to correspond to specific signals and channels. The dynamic adaptation of these spatial elements has significant implications for UE operations, affecting aspects such as measurements, CSI feedback, power control, Physical Uplink Shared Channel (PUSCH)/Physical Downlink Shared Channel (PDSCH) repetition, Sounding Reference Signal (SRS) transmission, TCI configuration, beam management, beam failure recovery, radio link monitoring, cell (re)selection, handover, and initial access. Feedback and assistance information from the UE play a crucial role in facilitating dynamic spatial element adaptation, necessitating inputs such as CSI measurements and reports, as well as SR. Various signaling methods, including those aimed at reducing signaling overhead, are employed to enable dynamic spatial element adaptation, with examples including group-common L1 signaling, broadcast signaling, and MAC CE.

In conventional methods, adaptation of the spatial elements and power offset are done at gNB without any feedback from the UE. Hence, the gNB does not consider change in beam shape due to adaptation and therefore can negatively impact per user rate or cell sum rate.

Unlike the conventional methods, the present disclosure consider feedback from the UE for the adaptation pattern in the spatial and power domain. Also, change in the beam shape due to the spatial and power domain adaptation and updating QCL relationship between source RS and target RS via the TCI indication is proposed in the present disclosure. Further, method for application of beam in the UE is also considered.

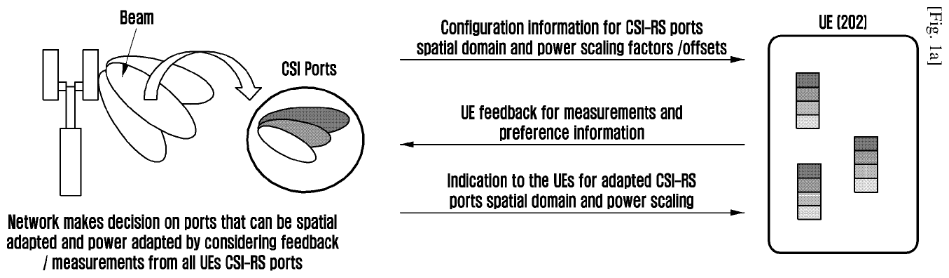

Referring now to the drawings and more particularly to FIGS. 1A through 10, where similar reference characters denote corresponding features consistently throughout the figure, these are shown preferred embodiments.

FIG. 1A illustrates an overview of the wireless network for managing energy usage, accordingly to embodiments as disclosed herein. The wireless network can be, for example, but not limited to a fourth generation (4G) network, a fifth generation (5G) network, a sixth generation (6G) network, an Open Radio Access Network (ORAN) or the like. In an embodiment, the wireless network includes a UE (202) and a network apparatus (201). The UE (202) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (202) can be, for example, but not limited to a gNB, a eNB, a new radio (NR) trans-receiver or the like.

In an embodiment, a UE feedback information can be used to identify which CSI-RS ports can have their power boosted/de-boosted, CSI-RS ports to be muted. The network apparatus (202) (e.g., gNB or the like) receives Reference Signal Received Quality (RSRP) measurements for all CSI-RS ports, and performs the following:
if the minimum RSRP received from all UEs (202) for certain port(s) is above a configured threshold, the port(s) can be candidate(s) for de-boosting power and muting or unmuting; or
if the maximum RSRP received from all UEs (202) for certain port(s) is below a configured threshold, the port(s) can be candidate(s) for boosting power, and muting or unmuting.

FIG. 1B is schematic diagram that illustrates AAS, according to prior art. As per current specifications and possible implementations of the AAS, the CSI-RS ports are mapped to Transceiver (TxRUs) and the TxRUs are mapped to physical antenna. In typical AAS implementations, the TxRUs are associated with Radio Frequency (RF) chain and Power Amplifiers (PA). As per the existing implementations, The PAs and RF chain consume 70% of the base stations power and therefore, are prime candidates for investigation of efficient operation from network energy perspective. In current RAN-1 discussions, SD and PD adaptation of CSI-RS ports are considered key tools to save network energy as per traffic load or geographical distribution of the users.

The AAS typically have a plurality of antenna elements and the number of antennas may be greater than the number of TxRUs. This means that each TxRUs may be connected to multiple antenna elements. Each transceiver may be connected to a single column of antenna elements to provide basic horizontal beamforming. However, logical antenna ports may be specified rather than physical antenna elements in 3GPP Specifications. Specific transmissions may use specific antenna ports which are mapped onto one or more physical antenna elements. For example, it is assumed that there are two antenna ports, one PDSCH and its DMRS may be associated with one antenna port and another PDSCH and its DMRS may be associated with the other antenna port. The UE (202) may not require knowledge of which physical antenna elements and TxRUs are used for the two transmissions.

In addition, there may be a one-to-many mapping between the antenna ports and the physical antenna elements. This mapping may be beneficial for beamforming that uses multiple physical antenna elements to direct the downlink transmissions towards a specific UE.

The logical antenna port setting may indicate the maximum number of DL antenna ports for CSI-RS, Synchronization Signal Block (SSB), DMRS, Tracking Reference Signal (TRS) or PDSCH. The logical antenna port setting may also indicate the maximum number of UL antenna ports for the SRS, DMRS, TRS, or PUSCH. If the maximum number of DL or UL antenna ports is smaller than the configured antenna ports for transmission or reception, the UE may skip the reception or drop the transmission.

An antenna port may be associated with one or more reference signals. The receiver may assume that the one or more reference signals, associated with the antenna port, may be used for estimating channel corresponding to the antenna port. The reference signals may be used to derive channel state information related to the antenna port. Two antenna ports may be referred to as quasi co-located if characteristics (e.g., large-scale properties) of the channel over which a symbol is conveyed on one antenna port may be inferred from the channel over which a symbol is conveyed from another antenna port. For example, a UE may assume that radio channels corresponding to two different antenna ports have the same large-scale properties if the antenna ports are specified as quasi co-located. In some cases, the UE may assume that two antenna ports are quasi co-located based on signaling received from the base station. Spatial QCL between two signals may be, for example, due to the two signals being transmitted from the same location and in the same beam. If a receive beam is good for a signal in a group of signals that are spatially quasi co-located, it may be assumed also be good for the other signals in the group of signals.

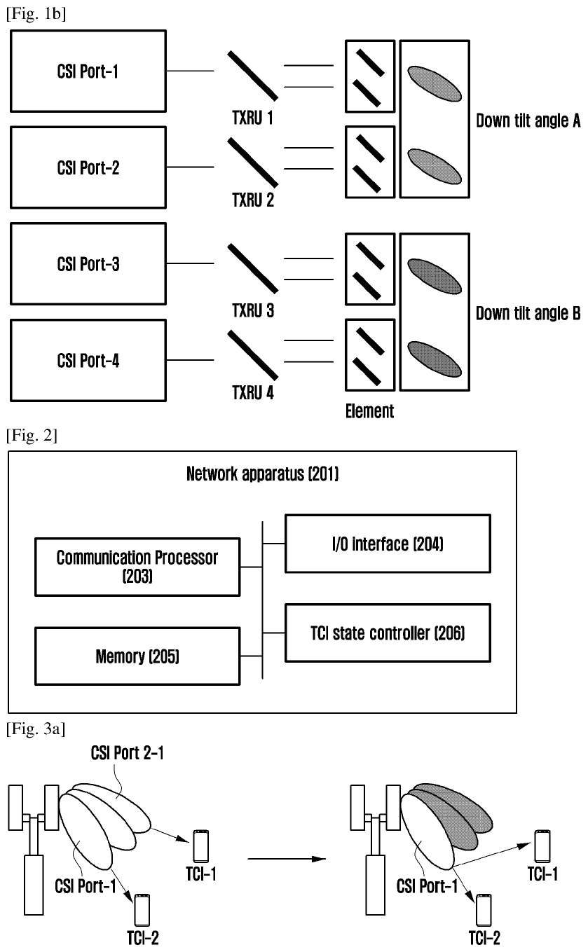

FIG. 2 is a block diagram of the network apparatus (201) for indicating change in the TCI states due to the dynamic adaptation of spatial elements in the wireless network, accordingly to embodiments as disclosed herein. In an embodiment, the network apparatus (201) includes a memory (205), a communication processor (203), an Input/Output (I/O) interface (204), and a TCI state controller (206).

The memory (205) is configured to store instructions to be executed by the communication processor (203). The memory (205) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (205) may, in some examples, be considered a non-transitory storage medium. The term “non-transitory” may indicate that the storage medium is not embodied in a carrier wave or a propagated signal. However, the term “non-transitory” should not be interpreted that the memory (205) is non-movable. In some examples, the memory (205) is configured to store larger amounts of information. In certain examples, a non-transitory storage medium may store data that can, over time, change (e.g., in Random Access Memory (RAM) or cache).

The communication processor (203) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The communication processor (203) may include multiple cores and is configured to execute the instructions stored in the memory (205).

The I/O interface (204) transmits the information between the memory (205) and external peripheral devices. The peripheral devices are the input-output devices associated with the network apparatus. The I/O interface (204) receives several information from plurality of UEs, network devices, server and the like.

In an embodiment, the TCI state controller (206) of the network apparatus (201) communicates with the processor (203), I/O interface (204) and memory (205) for indicating change in the TCI states due to the dynamic adaptation of the spatial elements in the wireless network. The TCI state controller (206) detects the TCI state for the PDCCH, wherein the TCI state defines the QCL relationship between DL RSs in the at least one CSI-RS resource set and the at least one DM-RS port of the PDCCH. Further, the TCI state controller (206) changes the QCL relationship between the DL RSs in the at least one CSI-RS resource set and the at least one DM-RS port of the PDCCH in the TCI state based on the plurality of parameters, and the SD and PD adaption. The changed TCI state is indicated to at least one UE associated with the network apparatus (201) in the wireless network by the TCI state controller (206).

In an embodiment, the TCI state controller (206) receives a CSI feedback from the at least one UE (202) associated with the network apparatus (201) in the wireless network, and mutes the at least one of ‘at least one CSI-RS port of the CSI-RS resource from the at least one CSI-RS resource set’, and ‘at least one spatial element of a plurality of spatial elements within at least one CSI-RS port from of the CSI-RS resource the at least one CSI-RS resource set’ based on the plurality of parameters, and the CSI feedback received from the at least one UE (202). Further, the changed QCL relationship is regenerated in the TCI state by the TCI state controller (206) based on the at least one of ‘the at least one muted CSI-RS port of the CSI-RS resource from the at least one CSI-RS’ resource and ‘the at least one muted spatial element within at least one CSI-RS port of the CSI-RS resource from the at least one CSI-RS resource set’.

In an embodiment, the TCI state controller (206) unmutes the at least one of ‘the at least one muted CSI-RS port of the CSI-RS resource from the at least one CSI-RS resource set’, and ‘at least one spatial element of the plurality of spatial elements within the at least one CSI-RS port of the CSI-RS resource from the at least one CSI-RS set’ based on the plurality of parameters, and the CSI feedback received from the at least one UE (202). Further, the changed QCL relationship is regenerated in the TCI state by the TCI state controller (206) based on the at least one of ‘the at least one unmuted CSI-RS port of the CSI-RS resource from the at least one CSI-RS resource set’ and ‘the at least one unmuted spatial element within at least one CSI-RS port of the CSI-RS resource from the at least one CSI-RS set’.

In an embodiment, the TCI state controller (206) transmits a CSI-RS resource sub-configuration across at least one of one or more BWP and one or more CC based on the changed TCI state to operate the at least one UE with the one or more CC in the one or more BWP.

In an embodiment, the UE (202) receives the changed TCI state from the network apparatus (201), wherein the changed TCI state indicates change in the QCL relationship between the DL RSs in the at least one CSI-RS set and the at least one DMRS port of the PDCCH in the TCI state based on a plurality of parameters. Further, the UE (202) performs at least one of a BWP operation and a CC operation based on the changed TCI state.

In an embodiment, the TCI state controller (206) transmits CSI-RS from the CSI-RS resource set associated with SD and PD sub-configurations configured for the SD and PD adaption in the wireless network.

The TCI state controller (206) is an inventive hardware component that is incorporated into the network apparatus (201) through processing circuitry, comprising of logic gates, integrated circuits, microprocessors, microcontrollers, memory circuits, passive and active electronic components, optical components, hardwired circuits, or similar technologies. These circuits can be manifested in one or more semiconductor chips or on substrate supports such as printed circuit boards.

At least one of the plurality of components of the cell selection controller (206) may be implemented through an AI model. A function associated with the AI model may be performed through the memory (205) and the processor (203). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Whilst FIG. 2 depicts the hardware components of the network apparatus (201), it should be noted that alternative embodiments are not confined to these elements. The network apparatus (201) may comprise a greater or lesser number of hardware components in other embodiments. Additionally, the labels or names assigned to these elements are purely for illustrative purposes and do not restrict the scope of the invention. Furthermore, it is possible for one or more components to be merged together to perform the same or a substantially similar function.

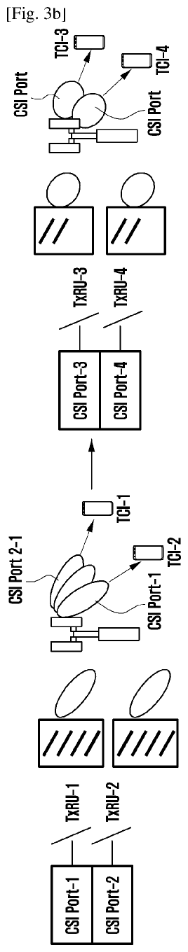

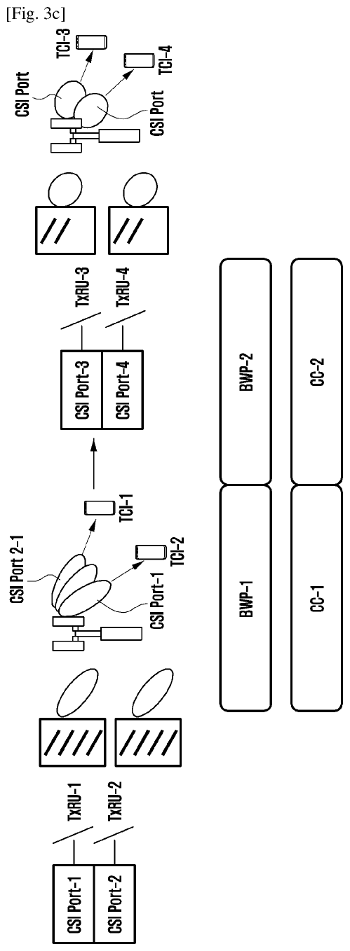

FIG. 3A depicts a type 1 SD adaption of the CSI-RS ports for network energy saving, accordingly to the embodiments as disclosed herein. In Type 1 SD adaptation, CSI-RS ports are considered for muting based on the plurality of parameters which includes feedback from the users as well. It should be noted that each TxRU have its own electrical tilt in azimuth and elevation directions. However, 3GPP has left the same up to gNB implementation. The TCI state is assumed to correspond to beam direction between the UE (202) and the network apparatus (201). The TCI state also performs the book-keeping of quasi-collocation information between different reference signals and data/control channels. In network energy saving operation, the CSI-RS ports could be muted, which will essentially impact the beam shape and in turn, invalidate quasi-collocation relationships for one or more UEs.

In an embodiment, the QCL relationship defines small scale fading relationship across the CSI-RS resources and the TCI state maintains book keeping for QCL relationship across CSI-RS resources.

FIG. 3B depicts a type 2 SD adaption of the CSI-RS ports for the network energy saving, accordingly to the embodiments as disclosed herein. In type 2 SD adaptation, spatial elements within the CSI ports are muted, which will have no impact on the number of CSI ports but beam-shapes for the CSI port(s) will change. It should be noted that decrease/increase in number of antenna elements, particularly within a sub-array (Type 2 SD), will impact the array gains and will eventually impact the beam shape. Change in beam shape will have similar impact on the TCI states as mentioned for Type 1 SD adaptation, thereby invalidating QCL relationship between the reference signals and data/control channels.

FIG. 3C depicts transmission of the CSI-RS resource sub-configuration across BWP and CC based on the changed TCI state, accordingly to the embodiments as disclosed herein. As per existing 3GPP implementation, the UE (202) could be configured to operate with one or more component carrier (CC) in certain bandwidth part (BWP). It should be noted that spatial domain adaptation are applicable for time- and frequency-domain equally, therefore change in TCI state due to Type 1/2 SD adaptation, and PD adaption could be considered across BWP and CC. In a given network deployment, the UEs could be associated with multiple BWPs and CCs, however change in spatial elements at the bases station would impact the beam shape, which will be eventually impact associated TCIs across and BWP and CCs.

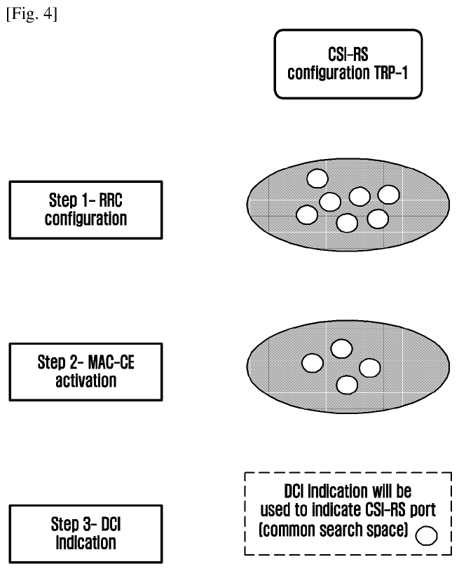

FIG. 4 is a schematic diagram that illustrates indication of the TCI state change due to adaption of the spatial elements, accordingly to the embodiments as disclosed herein. The network energy saving operation will result in frequent CSI and TCI configurations at Radio Resource Control (RRC). RRC reconfiguration mechanism is slower in operation, therefore will result in scheduling inefficiency. Dynamic signaling at the DCI or MAC CE will minimize the latency for adaptation. The CSI reconfiguration is done at the RRC, MAC-CE can be used for activation and deactivation of the CSI-RS ports as per the SD and PD adaptation pattern and the DCI can be used to indicate the CSI-RS reconfiguration as per existing NES operation. Muting/unmuting or power adaptation of the spatial elements may change the beam width. Since change of beam width may not change the average delay (since main path would remain same) while changing the delay spread due to increased number of multipath. This can lead to invalidation of any previous QCL-TypeA relationships between the CSI-RS and data/control channels. Likewise, spatial Rx filter may also change based on the subset of antenna elements used for muting or power adaptation, invalidating previous QCL-TypeD relationships. In a wide sense, for a UE, in the TCI state and CSI-RS for a muting pattern are coupled and therefore should be indicated together in the DCI. The MAC-CE activation and DCI indication (in the Unified TCI configuration framework) could be enhanced for SD adaptation.

Muting of spatial elements during Type 1 or Type 2 SD adaptation may impact the beam pattern, which can, in turn, have a bearing on the TCI state. For example, Type 2 SD adaptation may change beam-width which may consequently change the channel delay spread, without changing the average delay, thereby invalidating any previous QCL-TypeA relationships. Likewise, the spatial Rx filter may change based on the subset of spatial elements considered for muting (Type 1/Type 2 SD adaptation), invalidating any previous QCL-TypeD relationships. As mentioned previously, the UE (202) may be configured with multiple reference CSI resource sub-configurations (e.g., parameters like resourceMapping, powerControlOffsetSS and powerControlOffset). Defining separate TCT states for each of the SD and PD sub-configurations may lead to an extremely large number of new TCI states, which will complicate activation via the MAC-CE and/or indication via the DCI. Instead, additional TCI indexes can be defined corresponding to the changed TCI state in the CSI-RS resource sub-configurations due to the SD and PD adaption, to be used along with existing TCI codepoints. An existing DCI (and/or MAC-CE) format can be extended with extra fields to indicate these additional TCI indexes using the CSI-RS resource sub-configuration ID.

In an embodiment, since changes in the antenna ports during the SD/PD adaptation affects all the different BWP/CC in operation, these additional TCI indexes corresponding to the CSI-RS resource sub-configurations can be shared across different BWP and CC.

In an embodiment, existing unified TCI framework is extended for the SD/PD adaptation by using a CSI-RS resource sub-configuration ID in addition to the existing TCI codepoints. Furthermore, these sub-configuration IDs can be shared across different BWP and CC.

In an embodiment, timing of the NES configuration activation/deactivation may be, for example, determined based on explicit signaling (e.g., dynamically via an NES activation indication in the (DCI)). For example, two bits of an NES field in a DCI may be used for dynamic activation of a specific NES configuration (e.g., a preconfigured time, frequency, spatial, and/or power domain configuration). When the TxRUs setting has been changed, the CSI measurement which needs to be performed before the TxRUs change may become useless for the network node to perform link adaptation or beam management. As a result, the CSI report related to the useless CSI measurement may not be needed because the CSI report comprises the measured values before the TxRUs has been changed.

In some implementations, the indication of spatial element adaptation may comprises at least one of a CSI-RS resource, a CSI-RS resource set and a CSI-RS resource setting, and wherein the at least one of the CSI-RS resource, the CSI-RS resource set and the CSI-RS resource setting associates with one or more spatial adaptation patterns.

The spatial adaptation pattern may comprise a set of parameters which are used to determine a spatial element adaptation. In addition, the set of parameters may comprise at least one of spatial domain parameters, spectral domain parameters, and temporal domain parameters.

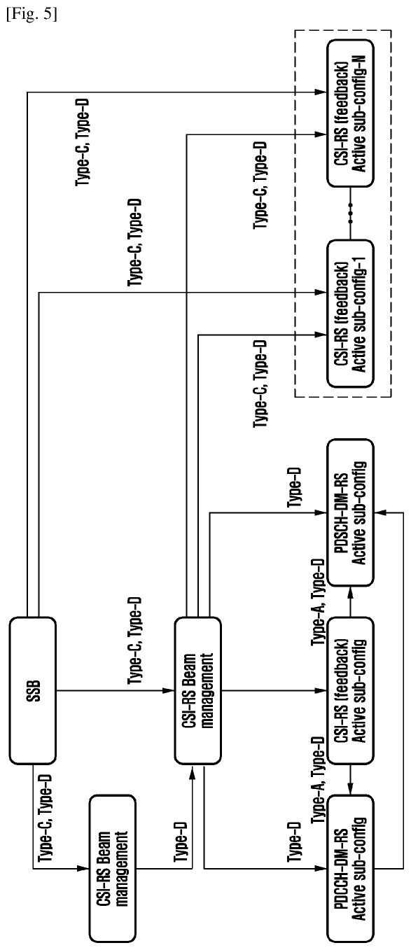

FIG. 5 is a schematic diagram that illustrates QCL types in beam management, accordingly to the embodiments as disclosed herein. The QCL relationship reflects the similarities in large-scale property of channel between source Reference Signal (RS) and target RS. The TCI framework provides assisted information related synchronization about the source RS before receiving the target RS for the channel measurement, control and data channel.

As an example SSB can QCLed with the CSI-RS (Beam management) and the CSI-RS (Channel feedback) via Type D, Type A and Type C. For FR2, each TCI state has one RS for the QCL type D, and one or more Type C and Type A. The TCI should be configured for data and control channel to infer QCL relationship i.e. CSI-RS (BM or feedback) are in QCLed with the PDCCH DMRS and with the PDSCH DMRS. The same is configured as TCI state in PDSCH and Control Resource Set (CORESET) configuration for the BWP/CC. As per current specification, at a given point in time, each target RS can only have one source RS for a given QCL type. Book-keeping of QCL relationship among reference signals are done by the TCI states. For example, change in beam-width may change delay-spread while average delay towards the UE would remain same.

As per existing methods, 128 TCI states can be configured by the RRC. For the PDCCH DMRS, MAC-CE activate one of the RRC configured states for the CORESET. For the PDSCH DMRS, MAC-CE selects up to eight TCI states from the list of configured TCI states and DCI indicates one of the eight activated TCI states for the PDSCH DMRS.

As per current agreements for the NES, the UE (202) measure the CSI-RS resources from the resource set for the candidate SD and PD sub-configurations and feedback CSI to the network apparatus (201). For active SD and PD sub-configuration, the TCI state could be configured as aforementioned legacy procures, however the TCI configuration of the candidate SD and PD sub-configurations is not discussed enough. Type1/Type2 SD and PD adaptation is likely to change the large-scale property of channel. As per current agreements, the UE (202) should feedback the CSI for the candidate sub-configurations, which reflects the small-scale property of the channel. In absence of the TCI states for the candidate set of sub-configurations, no QCL information is available for the CSI-RS measurements. This would result in inaccurate CSI measurements at UE(s), which will reflect in suboptimal selection of sub-configuration for SD and/or PD adaptation. Therefore, the present disclosure configure the TCI states for the SD and PD candidate sub-configurations. The TCI states for the candidate sub-configurations should be configured for UE(s) before the CSI measurements and feedback for the network apparatus (201) to select a sub-configuration for activation.

In an embodiment, the QCL types corresponding to each DL RS, specifically the port(s) or antenna port(s) of the DL RS, are determined by the higher layer parameter qcl-Type in QCL-Info. These QCL types can assume one of the following values: 1) ‘QCL-TypeA’: {Doppler shift, Doppler spread, average delay, delay spread}; 2) ‘QCLTypeB’: {Doppler shift, Doppler spread}; 3) ‘QCL-TypeC’: {Doppler shift, average delay}; and 4) ‘QCL-TypeD’: {Spatial RX parameter}. Configuration or indication of the QCL types occur in the TCI states for a RS. Although primarily utilized for the DL RS, QCL assumptions and the TCI states can be extended to UL RS if association via path loss RS and spatial relation are specified. The QCL assumption can be specified as follows: {RSi: QCL Type C to RS2}, {RSi: QCL Type C to RS2 and QCL Type D to RS3}. Consequently, RSi (destination or target RS) derives the specified properties according to the QCL types from the associated (source or reference) RSs (e.g., RS2). It's worth noting that the source RS may be a SSB, and both the source and destination RS may reside on the same carrier or different carriers (cross-carrier QCL). Moreover, QCL and TCI states can also be applied to scenarios where the target isn't necessarily a signal, such as a channel (e.g., PUCCH, PUSCH, PDSCH, PDCCH) or a resource.

In an embodiment, the CSI-RS in the downlink and the SRS in the uplink can function as QCL references for other physical downlink channels and physical uplink channels, respectively. For instance, a downlink physical channel like PDSCH or PDCCH may be spatially quasi-co-located with a downlink reference signal such as CSI-RS or SSB. In this scenario, the wireless device can determine a receive beam based on measurements of the downlink reference signal, assuming that the determined receive beam is also suitable for the reception of physical channels like PDSCH or PDCCH, which are spatially quasi-co-located with the downlink reference signal. Similarly, an uplink physical channel like PUSCH or PUCCH may be spatially quasi-co-located with an uplink reference signal like SRS. Here, the base station can determine a receive beam based on measurements of the uplink reference signal, assuming that the determined receive beam is also effective for the reception of physical channels like PUSCH or PUCCH, which are spatially quasi-co-located with the uplink reference signal.

In an embodiment, the DM-RSs facilitate channel estimation for coherent demodulation of downlink physical channels (e.g., PDSCH, PDCCH, and PBH) and uplink physical channels (e.g., PUSCH and PUCCH). These DM-RSs may be positioned early in the transmission (e.g., front-loaded DM-RS), enabling the receiver to acquire the channel estimate early and thereby reduce latency. The time-domain structure of the DM-RS (e.g., symbols in which the DM-RS is located within a slot) may vary based on different mapping types.

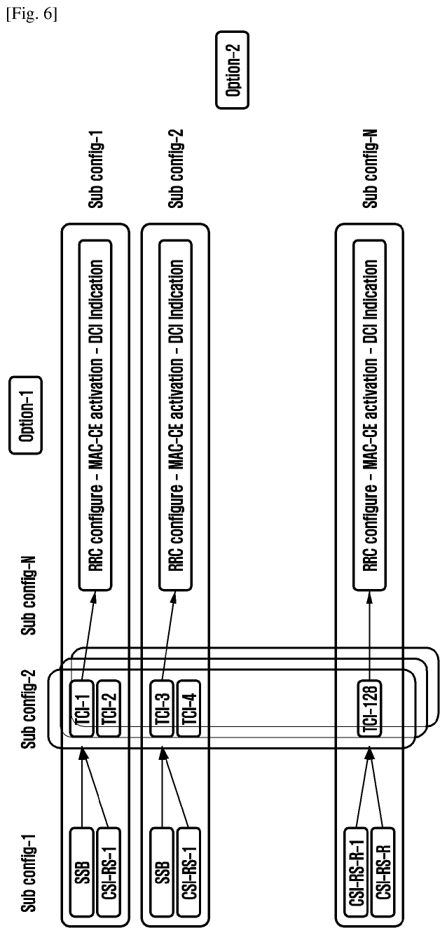

FIG. 6 is a schematic diagram that illustrates association of the TCI states with the SD and PD sub-configurations, accordingly to the embodiments as disclosed herein. In the NES, SD and/or PD power adaptation, after selection of the sub-configuration at the network apparatus (201), the sub-configuration should be activated via the MAC-CE and indicate via the DCI. Possible options of indication of TCI and sub-configuration to the UE(s) has already been discussed.

In an embodiment, the sub-configurations are associated with the TCI state(s) i.e. whole TCI pool is available for every sub-configuration. It should be noted that only one sub-configuration will be active at a given time. Once the sub-configuration is selected and activated by the network apparatus (201), the TCI state(s) associated with earlier sub-configuration will no more remain valid. The sub-configuration Index, could be treated as TCI group-ID, where, in same TCI-ID(s) could be reused for the active sub-configuration. The TCI(s) state and the sub-configuration association should be indicated to the UE(s) and TCI state(s) ID(s) should re-used by each active sub-configurations

The RRC configuration should inform mapping/association between the sub-configurations and TCI states to the UE(s). DCI field(s) in 1_1/1_2 with or without DL assignment should indicate the TCI state and associated sub-configuration.

Alternatively, the TCI states pool is split into multiples sub pool and associates with the sub-configurations i.e. whole TCI pool shared across the candidate sub-configurations. In this case, TCI(s) are associated with sub-configuration implicitly i.e. TCI state indication would implicitly indicate sub-configuration and therefore will avoid explicit association of the TCI(s) with sub-configuration. As per this method, there is no need for explicit association between the TCI and the sub-configuration and legacy procedures are sufficient.

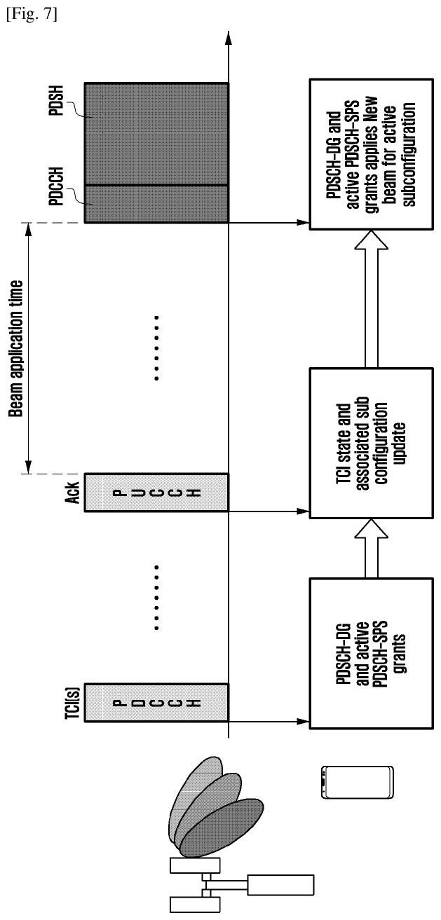

FIG. 7 is a schematic diagram that illustrates impact on beam application time in indicating changed TCI states to the UE (202), accordingly to the embodiments as disclosed herein. The beam application time is the time interval required to apply new beam on the PDCCH and PDSCH channel after receiving the TCI indication in the DCI, which requires the TCI associated with CORESET to be configured for the active BWP and CC.

As per current SD and PD adaptation procedure, it is implicitly understood that unless the network apparatus (201) select a new sub-configuration, active sub-configuration and associated TCI state(s) for the CSI-RS, PDDCH DMRS and the PDSCH DMRS will be used by control and data channel. After the indication of the sub-configuration associated with the TCI state DCI field(s) in 1_1/1_2 to the UE (202), new beam will be applicable after the beam application time (BAT). In case, if the DCI has indicated with DL assignment then the BAT will start after Hybrid Automatic Repeat Request-Acknowledgment (HARQ-ACK) of the associated PDSCH transmission.

For resource allocation DG-PDSCH and SPS-PDSCH grant, network apparatus (201) should indicate TCI state associated with sub-configuration to the UE (202) for PDSCH reception. The network apparatus (201) will allocate physical resources via PDSCH-DG and PDSCH SPS with activate sub-configuration, till the network apparatus (201) select new sub-configuration and indicate to the UE (202). After indication of new sub-configuration and associated TCI, beam will change after beam application time.

In an embodiment, an RRC parameter in a CORESET configuration is used to associate DL TCI state(s) with sub-configuration(s). When a scheduling/activation DCI is received in the CORESET, the indicated joint/DL TCI state(s) associated with the sub-configuration is applied to the PDSCH reception scheduled/activated by the scheduling/activation the DCI. The UE (202) shall apply the TCI state mapped to the TCI indicated by the DCI format 1_1/1_2 to PDSCH reception scheduled/activated by the DCI format 1_1/1_2. Hence, legacy procedure for the BAT are sufficient to handle the PDSCH-DG and PDSCH-SPS grants after new beam indication.

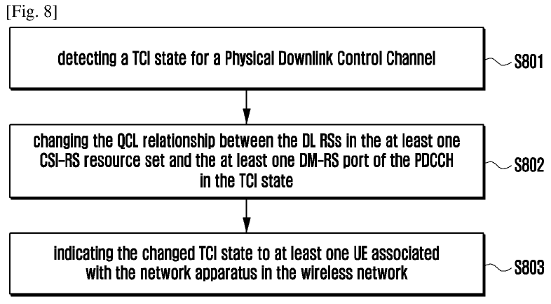

FIG. 8 is a sequence diagram that illustrates indicating change in the TCI state in the wireless network system, accordingly to the embodiments disclosed herein. At S801, the network apparatus (201) detects the TCI state for the PDCCH, wherein the TCI state defines the QCL relationship between the DL RSs in the at least one CSI-RS resource set and the at least one DM-RS port of the PDCCH.

At S802, the network apparatus (201) changes the QCL relationship between the DL RSs in the at least one CSI-RS resource set and the at least one DM-RS port of the PDCCH in the TCI state based on the plurality of parameters, and SD and PD adaption.

In an embodiment the plurality of parameters includes a feedback from a user of the at least one UE, a resource mapping, a power control parameter, a power control offset, muting pattern of antenna ports, antenna elements, joint adaptation of antenna ports, elements or power offset.

In an embodiment, the network apparatus (201) receives the CSI feedback from the at least one UE (202) associated with the network apparatus (201) in the wireless network, and mutes the at least one of ‘at least one CSI-RS port from of the CSI-RS resource the at least one CSI-RS resource set’, and ‘at least one spatial element of a plurality of spatial elements within at least one CSI-RS port of the CSI-RS resource from the at least one CSI-RS resource set’ based on the plurality of parameters, and the CSI feedback received from the at least one UE (202). Further, the changed QCL relationship is regenerated in the TCI state based on the at least one of ‘the at least one muted CSI-RS port of the CSI-RS resource from the at least one CSI-RS’ resource and ‘the at least one muted spatial element within at least one CSI-RS port of the CSI-RS resource from the at least one CSI-RS resource set’ by the network apparatus (201). In an embodiment, the network apparatus (201) unmutes the at least one of ‘the at least one muted CSI-RS port of the CSI-RS resource from the at least one CSI-RS resource set’, and ‘at least one spatial element of the plurality of spatial elements within the at least one CSI-RS port of the CSI-RS resource from the at least one CSI-RS set’ based on the plurality of parameters, and the CSI feedback received from the at least one UE (202). Further, the changed QCL relationship is regenerated in the TCI state based on the at least one of ‘the at least one unmuted CSI-RS port of the CSI-RS resource from the at least one CSI-RS set’ and ‘the at least one unmuted spatial element within at least one CSI-RS port of the CSI-RS resource from the at least one CSI-RS set’ by the network apparatus (201).

In an embodiment, the network apparatus (201) sends a configuration message comprising at least one power adaptation information to trigger at least one beam measurement report from the at least one UE (202), and receives the at least one beam measurement report from the at least one UE (202). Further the network apparatus (201) regenerates the changed QCL relationship in the TCI state based on the at least one power adaptation information and the at least one beam measurement report. In an embodiment, the network apparatus (201) indicates the at least one power adaptation information of the at least one CSI-RS port of the CSI-RS resource from the at least one CSI-RS resource set to the at least one UE (202), and receives a measurement report from the at least one UE (202) based on the at least one power adaptation information, wherein the measurement report comprises a preference and measurement information of the at least one power adaptation information of the at least one CSI-RS port of the CSI-RS resource from the at least one CSI-RS resource set. Further, the configuration message comprising the at least one power adaptation information is sent to the at least one UE (202) in the wireless network based on the measurement report.

In an embodiment, the power adaption information comprises status of the at least one of ‘at least one CSI-RS port of the CSI-RS resource from the at least one CSI-RS resource set’, and ‘at least one spatial element of the plurality of spatial elements within at least one CSI-RS port of the CSI-RS resource from the at least one CSI-RS resource set’.

In one embodiment, the network apparatus (201) sends the configuration message containing power adaptation information to one or more UEs (202) in the wireless network. This includes indicating the power adaptation information alongside one of the following: at least one CSI-RS port, a single group of CSI-RS ports, or multiple groups of CSI-RS ports for the UEs (202). The network apparatus (201) then receives a measurement report from the UEs (202) based on this indication and sends the configuration message containing the power adaptation information to the UEs (202) based on the received measurement report. The measurement report includes preferences and measurement information about the power adaptation information for the indicated CSI-RS port(s) or group(s). The contents of the measurement report include parameters like CSI-RS Resource Indicator (CRI), a Ranking Indicator (RI), a Layer Indicator (LI), a Pre-coding Matrix Indicator (PMI), and a Channel Quality Indicator (CQI). etc.

In an embodiment, the power adaptation information is provided through various methods such as de-boosting or boosting all CSI-RS ports with identical power scaling factors on the BWP or per CC basis, adjusting power on each CSI-RS port with different scaling factors on a per BWP or per CC basis, boosting power on a subset of the CSI-RS ports while de-boosting power on the rest with different scaling factors on a per BWP or per CC basis, or setting all the CSI-RS ports to the same reference power on a per BWP or per CC basis. For instance, identical power scaling factor implies that CSI for all CSI-RS ports in a CSI resource can be measured for both base power and 3 dB lower power, with potentially different RI values for the measured channels.

In one embodiment, the beam measurements in the wireless network include Reference Signal Received Power (RSRP), Signal to Interference Noise Ratio (SINR), Reference Signal Received Quality (RSRQ), CRI, RI, LI, PMI, and CQI. In another embodiment, power adaptation information indicates power offset values for configured CSI-RS resource sets or individual CSI-RS resources within the set. The power adaptation information is communicated to the UEs (202) by adjusting transmit power of CSI-RS ports themselves using powerControlOffsetSS values or updates associated with these values, or by adjusting transmit power of PDSCH quasi-colocated with CSI-RS ports using powerControlOffset values or updates associated with these values.

In an embodiment, the beam adaptation information is provided in different ways: widening or narrowing beam parameters for selected CSI-RS port sets from candidate lists with the same or different scaling factors on a per BWP or per CC basis. Widening beam parameters for one subset while narrowing for another non-overlapping subset from the candidate list. Widening or narrowing beam parameters along with power boosting or de-boosting for selected CSI-RS port subsets with corresponding scaling factors on a per BWP or per CC basis; widening beam parameters with power de-boosting for one subset while narrowing with power boosting for another non-overlapping subset; adjusting beam-width for two non-overlapping subsets with power boosting or de-boosting; and setting all CSI-RS ports to default beam adaptation information on a per BWP or per CC basis.

In one embodiment, the beam adaptation information linked to at least one CSI-RS port includes parameters such as beam width, beam angle, beam tilt, beam radiation pattern, and CSI-RS port power. In another embodiment, a single group of CSI-RS ports, in association with the beam adaptation information, encompasses similar parameters: beam width, beam angle, beam tilt, beam radiation pattern, and CSI-RS port power. Similarly, in another embodiment, multiple groups of CSI-RS ports associated with the beam adaptation information consist of parameters like beam width, beam angle, beam tilt, beam radiation pattern, and CSI-RS port power.

At step S803, the network apparatus (201) indicates the changed TCI state to the at least one UE (202) associated with the network apparatus (201) in the wireless network. The changed TCI state is indicated in one of the MAC-CE activation message, and the DCI Indication message. Wherein the MAC-CE activation message comprises an identifier of a CSI-RS resource sub-configuration, TCI indexes corresponding to the changed TCI state in the CSI-RS resource sub-configurations. The DCI message comprises an identifier of a CSI-RS resource sub-configuration, TCI indexes corresponding to the changed TCI state in the CSI-RS resource sub-configurations.

In an embodiment, the network apparatus (201) transmits the CSI-RS resource sub-configuration across at least one of one or more BWP and one or more CC based on the changed TCI state to operate the at least one UE with the one or more CC in the one or more BWP.

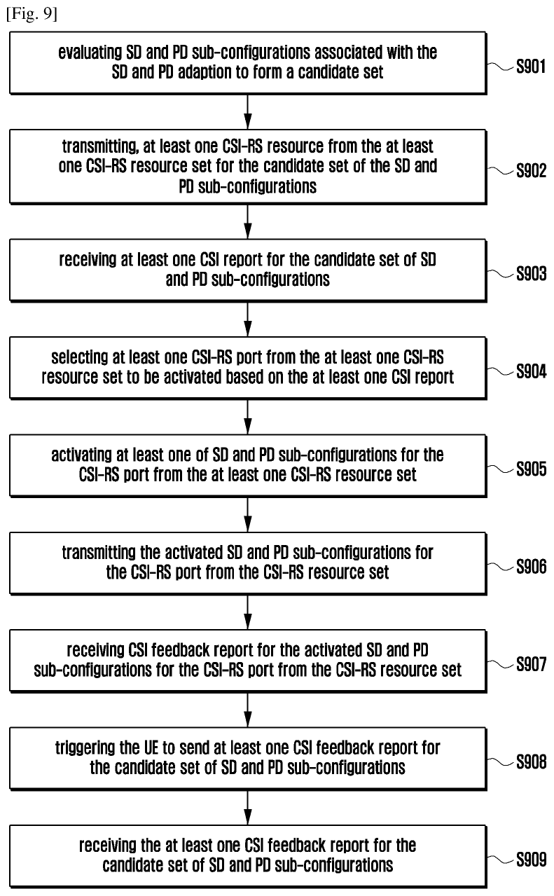

FIG. 9 is a flow diagram the illustrates transmission of the CSI-RS from the CSI-RS set associated with the SD and PD sub-configurations configured for the SD and PD adaption, accordingly to the embodiments as disclosed herein. At step S901, the network apparatus (201) evaluates the SD and PD sub-configurations associated with the SD and PD adaption to form the candidate set, wherein the candidate set is a set of spatial domain muting pattern or power offsets based sub configurations considered for the SD/PD adaption.

At step S902 the network apparatus (201) transmits the at least one CSI-RS resource from the at least one CSI-RS resource set for the candidate set of the SD and PD sub-configurations.

At step S903, the network apparatus (201) receives the at least one CSI report for the candidate set of the SD and PD sub-configurations.

At step S904, the network apparatus (201) selects the at least one CSI-RS port of the CSI-RS resource from the at least one CSI-RS resource set to be activated based on the at least one CSI report for the candidate set of the SD and PD sub-configurations.

At step S905, the network apparatus (201) activates the at least one of SD and PD sub-configurations for the at least one CSI-RS port of the CSI-RS resource from the at least one CSI-RS resource set.

At step S906, the network apparatus (201) transmits the at least one activated SD and PD sub-configurations for the at least one CSI-RS port of the CSI-RS resource from the at least one CSI-RS resource set.

At step S907 the network apparatus (201) receives the at least one CSI feedback report for the at least one activated SD and PD sub-configurations for the at least one CSI-RS port of the CSI-RS resource from the at least one CSI-RS resource set from the UE (202).

At step S908, the network apparatus (201) triggers the UE (202) to send the at least one CSI feedback report for the candidate set of the SD and PD sub-configurations. At step S909, the network apparatus (201) receives the at least one CSI feedback report for the candidate set of the SD and PD sub-configurations.

In an embodiment, as per the existing NES procedure, the CSI-RS resources from a resource set associated with SD and PD sub-configurations are configured for spatial and power domain adaptation. The network apparatus (201) indicates to the UE (202) to send the CSI reports associated with the sub-configurations in a single CSI or multiple CSI manner as per CSI prioritization. After receiving CSI feedback reports, the network apparatus (201) would pick the SD and/or PD pattern to maximize the network energy savings while maintaining fair balance with system throughput. Subsequently, the network apparatus (201) will indicate selected sub-configuration to the UEs (202).

In an embodiment, the network apparatus (201) would evaluate the sub-configuration to be activated from the candidate set and send to the UE(s) (202) via unicast or group-common signaling. The network apparatus (201) would configure the CSI-RS resource from the resource set for a resource setting for the configured candidate sub-configurations and thereby making the CSI-RS(s) available for UE measurements and providing the CSI-RS feedback. The UE(s) (202) will continue to measure the CSI-RS(s) and report the CSI feedback for precoder selection and link adaptation for the active sub-configuration. Once the network apparatus (201) indicates the UEs (202) to trigger measurements on the candidate set of sub-configurations, the UE(s) (202) will measure and report the CSI feedback on the configured CSI-RS(s) for the candidate set of sub-configurations. It should be noted that the network apparatus (201) will be transmitting the CSI-RS(s) for the configured candidate set of sub-configurations on periodic, aperiodic and semi-persistent basis.

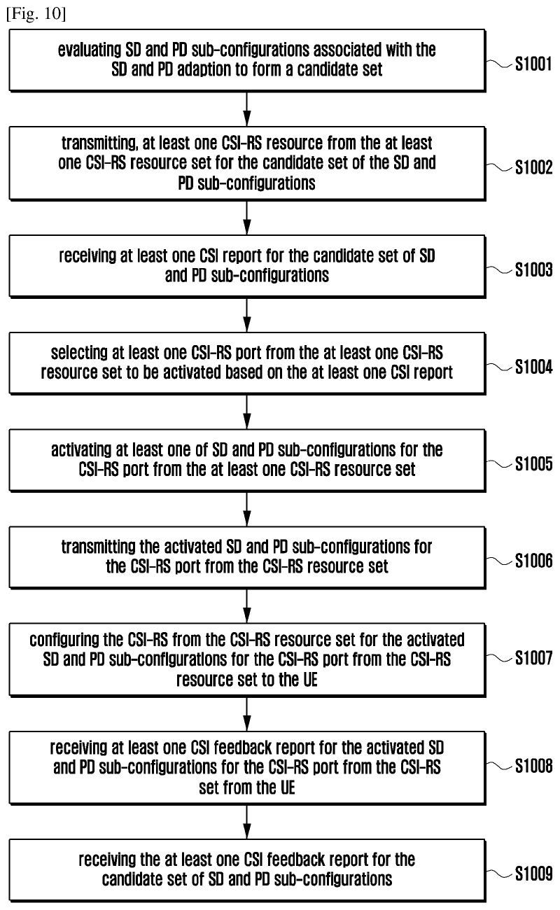

FIG. 10 is a flow diagram the illustrates the transmission of the CSI-RS from the CSI-RS set associated with the SD and PD sub-configurations configured for the SD and PD adaption, accordingly to the another embodiments as disclosed herein. At step S1001, the network apparatus (201) evaluates the SD and PD sub-configurations associated with the SD and PD adaption to form the candidate set, wherein the candidate set is a set of spatial domain muting pattern or power offsets based sub configurations considered for the SD/PD adaption.

At step S1002 the network apparatus (201) transmits the at least one CSI-RS resource from the at least one CSI-RS resource set for the candidate set of the SD and PD sub-configurations.

At step S1003, the network apparatus (201) receives the at least one CSI report for the candidate set of the SD and PD sub-configurations.

At step S1004, the network apparatus (201) selects the at least one CSI-RS port of the CSI-RS resource from the at least one CSI-RS resource set to be activated based on the at least one CSI report for the candidate set of the SD and PD sub-configurations.

At step S1005, the network apparatus (201) activates the at least one of SD and PD sub-configurations for the at least one CSI-RS port from the at least one CSI-RS resource set.

At step S1006, the network apparatus (201) transmits the at least one activated SD and PD sub-configurations for the at least one CSI-RS port of the CSI-RS resource from the at least one CSI-RS resource set.

At step S1007, the network apparatus (201) configures the at least one CSI-RS from of the CSI-RS resource the at least one CSI-RS resource set for the at least one activated SD and PD sub-configurations for the at least one CSI-RS port of the CSI-RS resource from the at least one CSI-RS resource set to the UE (202).

At step S1008, the network apparatus (201) receives the at least one CSI feedback report for the at least one activated SD and PD sub-configurations for the at least one CSI-RS port of the CSI-RS resource from the at least one CSI-RS set from the UE (202).

At step S1009, the at least one CSI feedback report for the candidate set of SD and PD sub-configurations is received at the network apparatus (201).

In an embodiment, the network apparatus (201) would evaluate sub-configuration to be activated from the candidate set and send to the UE(s) (202) via unicast of group common signaling. The network apparatus (201) would transmit the CSI-RS resource from resource set for a resource setting for the active sub-configuration. The UE(s) (202) will be measuring and reporting the CSI-RS(s) of the active sub-configuration for choice of precoder and link-adaptation. The network apparatus (201) would transmit the configured CSI-RS(s) for the candidate set sub-configurations on periodic, aperiodic and semi-persistent basis. The UE(s) (202) will measure and report the CSI feedback for the network apparatus (201) to re-select the sub-configuration for the activation purpose from the candidate set of sub-configurations. It should be noted that the network apparatus (201) will be transmitting the CSI-RS(s) for the configured set of sub-configurations and active sub-configuration as two different configurations on periodic, aperiodic and semi-persistent basis.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

### LIST TO REFERENCE NUMERALS

| Sl. No | Description |
|---|---|
| 1 | Network Apparatus (201) |
| 2 | User Equipment (202) |
| 3 | Communication Processor (203) |
| 4 | I/O interface (204) |
| 5 | Memory (205) |
| 6 | TCI state controller (206) |

1. A method performed by a network apparatus in a wireless communication system, the method comprising:
detecting, a transmission configuration indicator (TCI) state for a Physical Downlink Control Channel (PDCCH), wherein the TCI state defines a Quasi Co-Location (QCL) relationship between Downlink Reference Signals (DL RSs) in at least one Channel State Indicator-Reference Signal (CSI-RS) resource set and at least one Demodulation Reference Signal (DM-RS) port of the PDCCH;
changing, the QCL relationship between the DL RSs in the at least one CSI-RS resource set and the at least one DM-RS port of the PDCCH in the TCI state based on a plurality of parameters, and Spatial Domain (SD) and Power Domain (PD) adaption; and
indicating, the changed TCI state to at least one User Equipment (UE) (202) associated with the network apparatus (201) in the wireless network; wherein at least one parameters comprises a feedback from a user of the at least one UE (202), a resource mapping, a power control parameter, a power control offset, muting pattern of antenna ports, antenna elements, joint adaptation of antenna ports, elements or power offset, and
wherein the changed TCI state is indicated in one of a Medium Access Control-Control Element (MAC-CE) activation message, and a Downlink Scheduling Control Information (DCI) Indication message.

2. The method of claim 1, wherein changing the QCL relationship between the DL RSs in the at least one CSI-RS set and the at least one DM-RS port of the PDCCH in the TCI state based on the plurality of parameters, and SD and PD adaption comprises:
receiving, a CSI feedback from the at least one UE (202) associated with the network apparatus (201) in the wireless network.
muting, at least one of ‘at least one CSI-RS port of a CSI-RS resource from the at least one CSI-RS resource set’, and ‘at least one spatial element of a plurality of spatial elements within at least one CSI-RS port of the CSI-RS resource from the at least one CSI-RS resource set’ based on the plurality of parameters, and the CSI feedback received from the at least one UE (202); and
regenerating, the changed QCL relationship in the TCI state based on the at least one of ‘the at least one muted CSI-RS port of the CSI-RS resource from the at least one CSI-RS’ resource and ‘the at least one muted spatial element within at least one CSI-RS port of the CSI-RS resource from the at least one CSI-RS resource set’;
receiving, the CSI feedback from the at least one UE (202) associated with the network apparatus (201) in the wireless network unmuting, at least one of ‘the at least one muted CSI-RS port from the at least one CSI-RS resource set’, and ‘at least one spatial element of the plurality of spatial elements within the at least one CSI-RS port of the CSI-RS resource from the at least one CSI-RS set’ based on the plurality of parameters, and the CSI feedback received from the at least one UE (202);
regenerating, a changed QCL relationship in the TCI state based on the at least one of ‘the at least one unmuted CSI-RS port of the CSI-RS resource from the at least one CSI-RS set’ and ‘the at least one unmuted spatial element within at least one CSI-RS port of the CSI-RS resource from the at least one CSI-RS set’;
sending, a configuration message comprising at least one power adaptation information to trigger at least one beam measurement report from the at least one UE (202);
receiving, the at least one beam measurement report from the at least one UE (202); and
regenerating, a changed QCL relationship in the TCI state based on the at least one power adaptation information and the at least one beam measurement report.

3. The method of claim 2, wherein sending, the configuration message comprising at least one power adaptation information to trigger at least one beam measurement report from the at least one UE (202) comprises:
indicating, the at least one power adaptation information of the at least one CSI-RS port of the CSI-RS resource from the at least one CSI-RS resource set to the at least one UE (202);
receiving, a measurement report from the at least one UE (202) based on the at least one power adaptation information, wherein the measurement report comprises a preference and measurement information of the at least one power adaptation information of the at least one CSI-RS port of the CSI-RS resource from the at least one CSI-RS resource set; and
sending, the configuration message comprising the at least one power adaptation information to the at least one UE (202) in the wireless network based on the measurement report;
wherein the power adaption information comprises status of the at least one of ‘at least one CSI-RS port of the CSI-RS resource from the at least one CSI-RS resource set’, and ‘at least one spatial element of the plurality of spatial elements within at least one CSI-RS port of the CSI-RS resource from the at least one CSI-RS resource set’.

4. The method of claim 1, wherein the method further comprises:
sharing, a CSI-RS resource sub-configuration across at least one of one or more bandwidth part (BWP) and one or more component carrier (CC) based on the changed TCI state to operate the at least one UE (202) with the one or more CC in the one or more BWP;
wherein the MAC-CE activation message comprises an identifier of a CSI-RS resource sub-configuration, TCI indexes corresponding to the changed TCI state in the CSI-RS resource sub-configurations, and
wherein the DCI message comprises an identifier of a CSI-RS resource sub-configuration, TCI indexes corresponding to the changed TCI state in the CSI-RS resource sub-configurations.

5. The method of claim 1, wherein indicating the changed TCI state to the at least one UE (202) associated with the network apparatus (201) in the wireless network comprises:
evaluating, SD and PD sub-configurations associated with the SD and PD adaption to form a candidate set, wherein the candidate set is a set of spatial domain muting pattern or power offsets based sub configurations considered for SD/PD adaption;
transmitting, at least one CSI-RS resource from of the CSI-RS resource the at least one CSI-RS resource set for the candidate set of the SD and PD sub-configurations;
receiving, at least one CSI report for the candidate set of SD and PD sub-configurations;
selecting, at least one CSI-RS port of the CSI-RS resource from the at least one CSI-RS resource set to be activated based on the at least one CSI report for the candidate set of SD and PD sub-configurations; and
activating, at least one of SD and PD sub-configurations for the at least one CSI-RS port of the CSI-RS resource from the at least one CSI-RS resource set.

6. The method of claim 5, wherein the method comprises:
transmitting, the at least one activated SD and PD sub-configurations for the at least one CSI-RS port of the CSI-RS resource from the at least one CSI-RS resource set;
receiving, at least one CSI feedback report for the at least one activated SD and PD sub-configurations for the at least one CSI-RS port of the CSI-RS resource from the at least one CSI-RS resource set from the UE (202);
triggering, the UE (202) to send at least one CSI feedback report for the candidate set of SD and PD sub-configurations;
receiving, the at least one CSI feedback report for the candidate set of SD and PD sub-configurations;
configuring, the at least one CSI-RS from of the CSI-RS resource the at least one CSI-RS resource set for the at least one activated SD and PD sub-configurations for the at least one CSI-RS port of the CSI-RS resource from the at least one CSI-RS resource set to the UE (202);
receiving, at least one CSI feedback report for the at least one activated SD and PD sub-configurations for the at least one CSI-RS port of the CSI-RS resource from the at least one CSI-RS set from the UE (202); and
receiving, the at least one CSI feedback report for the candidate set of SD and PD sub-configurations.

7. The method of claim 5,
wherein the at least one CSI-RS from the at least one CSI-RS set for the configured candidate set of the SD and PD sub-configurations is transmitted on periodic, aperiodic and semi-persistent basis, and
wherein the at least one CSI-RS from the at least one CSI-RS set for the at least one of the candidate set of SD and PD sub-configurations and the active SD and PD sub-configurations is configured on periodic, aperiodic and semi-persistent basis.

8. The method of claim 5, wherein association of the SD and PD sub-configurations with TCI states comprises at least one of:
reusing, at least one TCI-ID for the each SD and PD sub-configurations; and
splitting, at least one TCI-ID into multiple pool of ID(s) and associating each pool with the SD and PD sub-configurations.

9. A network apparatus (201) for in a wireless communication system, the network apparatus (201) comprising:
a memory (205);
a communication processor (203);
an I/O interface (204); and
a transmission configuration indicator (TCI) state controller (206) communicatively coupled to the memory (205), the communication processor (203) and the I/O interface (204), wherein the TCI state controller (206) is configured to:
detect a TCI state for a Physical Downlink Control Channel (PDCCH), wherein the TCI state defines a Quasi Co-Location (QCL) relationship between Downlink Reference Signals (DL RSs) in at least one Channel State Indicator-Reference Signal (CSI-RS) resource set and at least one Demodulation Reference Signal (DM-RS) port of the PDCCH, change the QCL relationship between the DL RSs in the at least one CSI-RS resource set and the at least one DM-RS port of the PDCCH in the TCI state based on a plurality of parameters, and Spatial Domain (SD) and Power Domain (PD) adaption,
indicate the changed TCI state to at least one User Equipment (UE) (202) associated with the network apparatus (201) in the wireless network, and
share, a CSI-RS resource sub-configuration across at least one of one or more bandwidth part (BWP) and one or more component carrier (CC) based on the changed TCI state to operate the at least one UE (202) with the one or more CC in the one or more BWP,
wherein the plurality of parameters comprises a feedback from a user of the at least one UE (202), a resource mapping, a power control parameter, a power control offset, muting pattern of antenna ports, antenna elements, joint adaptation of antenna ports, elements or power offset, and
wherein the changed TCI state is indicated in one of a Medium Access Control-Control Element (MAC-CE) activation message, and a Downlink Scheduling Control Information (DCI) Indication message.

10. The network apparatus of claim 9, wherein the TCI state controller (206) is further configured to:
receive, a CSI feedback from the at least one UE (202) associated with the network apparatus (201) in the wireless network,
mute, at least one of ‘at least one CSI-RS port from the at least one CSI-RS resource set’, and ‘at least one spatial element of a plurality of spatial elements within at least one CSI-RS port of a CSI-RS resource from the at least one CSI-RS resource set’ based on the plurality of parameters, and the CSI feedback received from the at least one UE (202),
regenerate, the changed QCL relationship in the TCI state based on the at least one of ‘the at least one muted CSI-RS port of the CSI-RS resource from the at least one CSI-RS’ resource and ‘the at least one muted spatial element within at least one CSI-RS port of the CSI-RS resource from the at least one CSI-RS resource set’,
receive, the CSI feedback from the at least one UE (202) associated with the network apparatus (201) in the wireless network,
unmute, at least one of ‘the at least one muted CSI-RS port of the CSI-RS resource from the at least one CSI-RS resource set’, and ‘at least one spatial element of the plurality of spatial elements within the at least one CSI-RS port of the CSI-RS resource from the at least one CSI-RS set’ based on the plurality of parameters, and the CSI feedback received from the at least one UE (202),
regenerate, a changed QCL relationship in the TCI state based on the at least one of ‘the at least one unmuted CSI-RS port of the CSI-RS resource from the at least one CSI-RS set’ and ‘the at least one unmuted spatial element within at least one CSI-RS port of the CSI-RS resource from the at least one CSI-RS set’,
send, a configuration message comprising at least one power adaptation information to trigger at least one beam measurement report from the at least one UE (202),
receive, the at least one beam measurement report from the at least one UE (202), and
regenerate, a changed QCL relationship in the TCI state based on the at least one power adaptation information and the at least one beam measurement report.

11. The network apparatus of claim 10, wherein the TCI state controller (206) is further configured to:
indicate, the at least one power adaptation information of the at least one CSI-RS port of the CSI-RS resource from the at least one CSI-RS resource set to the at least one UE (202),
receive, a measurement report from the at least one UE (202) based on the at least one power adaptation information, wherein the measurement report comprises a preference and measurement information of the at least one power adaptation information of the at least one CSI-RS port of the CSI-RS resource from the at least one CSI-RS resource set, and
send, the configuration message comprising the at least one power adaptation information to the at least one UE (202) in the wireless network based on the measurement report,
wherein the power adaption information comprises status of the at least one of ‘at least one CSI-RS port of the CSI-RS resource from the at least one CSI-RS resource set’, and ‘at least one spatial element of the plurality of spatial elements within at least one CSI-RS port of the CSI-RS resource from the at least one CSI-RS resource set’.

12. The network apparatus of claim 9,
wherein the MAC-CE activation message comprises an identifier of a CSI-RS resource sub-configuration, TCI indexes corresponding to the changed TCI state in the CSI-RS resource sub-configurations, and
wherein the DCI message comprises an identifier of a CSI-RS resource sub-configuration, TCI indexes corresponding to the changed TCI state in the CSI-RS resource sub-configurations.

13. The network apparatus of claim 9, wherein the TCI state controller (206) is further configured to:
evaluate, SD and PD sub-configurations associated with the SD and PD adaption to form a candidate set, wherein the candidate set is a set of spatial domain muting pattern or power offsets based sub configurations considered for SD/PD adaption,
transmit, at least one CSI-RS resource from the at least one CSI-RS resource set for the candidate set of the SD and PD sub-configurations, receive, at least one CSI report for the candidate set of SD and PD sub-configurations,
select, at least one CSI-RS port of the CSI-RS resource from the at least one CSI-RS resource set to be activated based on the at least one CSI report for the candidate set of SD and PD sub-configurations, and
activate, at least one of SD and PD sub-configurations for the at least one CSI-RS port of the CSI-RS resource from the at least one CSI-RS resource set.

14. The network apparatus of claim 13, wherein the TCI state controller (206) is further configured to:
transmit, the at least one activated SD and PD sub-configurations for the at least one CSI-RS port of the CSI-RS resource from the at least one CSI-RS resource set,
receive, at least one CSI feedback report for the at least one activated SD and PD sub-configurations for the at least one CST-RS port of the CSI-RS resource from the at least one CSI-RS resource set from the UE (202),
trigger, the UE (202) to send at least one CSI feedback report for the candidate set of SD and PD sub-configurations,
receive, the at least one CSI feedback report for the candidate set of SD and PD sub-configurations,
configure, the at least one CSI-RS from the at least one CSI-RS resource set for the at least one activated SD and PD sub-configurations for the at least one CSI-RS port of the CSI-RS resource from the at least one CSI-RS resource set to the UE (202),
receive, at least one CSI feedback report for the at least one activated SD and PD sub-configurations for the at least one CSI-RS port of the CSI-RS resource from the at least one CSI-RS set from the UE (202), and
receive, the at least one CSI feedback report for the candidate set of SD and PD sub-configurations,
wherein the at least one CSI-RS from the at least one CSI-RS set for the configured candidate set of the SD and PD sub-configurations is transmitted on periodic, aperiodic and semi-persistent basis, and
wherein the at least one CSI-RS from the at least one CSI-RS set for the at least one of the candidate set of SD and PD sub-configurations and the active SD and PD sub-configurations is configured on periodic, aperiodic and semi-persistent basis.

15. The method of claim 13, wherein the TCI state controller (206) is further configured to:
reuse, at least one TCI-ID for the each SD and PD sub-configurations, and
split, at least one TCI-ID into multiple pool of ID(s) and associating each pool with the SD and PD sub-configurations
